(19) United States
(12) Patent Application Publication
(10) Pub. No.: US 2007/0031773 A1
(43) Pub. Date: Feb. 8, 2007

(54) Bracket for orthodontics

(76) Inventor: Giuseppe Scuzzo, Ostia Lido (IT)

Correspondence Address: LEFFERT JAY & POLGLAZE, P.A., P.O. BOX 581009, MINNEAPOLIS, MN, 55458-1009, US

(21) Appl. No.: 10/565,491

(22) PCT Filed: Jul. 21, 2003
(86) PCT No.: PCT/IT03/00449

§ 371 Date: Sep. 21, 2006

(51) Int. Cl. A61C 3/00

(52) U.S. Cl. 433/10

(57) ABSTRACT

A bracket for lingual orthodontics, comprising a base (2) to be fastened onto the lingual side of a tooth, three engaging tabs (4, 5, 6) adapted to engage and hold a system (9) for binding the dental arc, a housing (3) for an orthodontic wire (8) which extends along the dental arc, and a member (7) for retaining the orthodontic wire within said housing (3), which extends only along a limited segment thereof and facing the housing (3) in such a way as to abut the orthodontic wire (8) received in said housing (3).

The present invention relates to a bracket for use in lingual orthodontics and to an orthodontic implant therefor. In particular, the invention relates to an orthodontic bracket of the type comprising a base adapted to be fastened onto the lingual side of a tooth, one or more engaging tabs to hold a fastening system for the dental arc and a housing for an orthodontic wire extending along the dental arc.

The term “lingual orthodontics” generally means the technique which consists of placing orthodontic implants on the lingual side of the teeth. Such implants typically consist of a plurality of brackets, each fastened to a respective tooth. Through these brackets is placed an orthodontic wire, in such a way that the wire extends along the dental arc. The orthodontic wire, which can have circular, square or rectangular cross section, and different metallic composition, is brought to a desired tensioning state, both for containment purposes and for corrective dental movements.

Lingual orthodontics offers important aesthetic and bio-mechanical advantages over labial orthodontics. Its implants are invisible from the exterior and, bio-mechanically, they entail advantages for the application of forces relative to the axis passing through the centre of resistance of the tooth. All with the same therapeutic results as traditional external (labial) orthodontic techniques.

However, currently available lingual brackets have some drawbacks. First of all, they do not allow a satisfactory control over rotation, due to the reduced flexural and torsional capabilities of the orthodontic wire, to the detriment of the therapeutic effects and of the time required to achieve them.

Moreover, they have rather large dimensions, in particular in terms of thickness, and this makes them not very comfortable for the patient in terms of tactile perception of the tongue and hygiene. Also because of such excessive dimensions, the patient generally experiences speech difficulties.

The technical problem constituting the basis for the present invention, therefore, is to provide an orthodontic bracket which allows to overcome the drawbacks mentioned above with reference to the prior art.

Said problem is solved by an orthodontic bracket according to claim 1.

According to the same inventive concept, the present invention also relates to an orthodontic implant according to claim 15.

Preferred characteristics of the present invention are set out in the dependent claims thereof.

The present invention achieves some considerable advantages.

The main advantage consists in the fact that the invention, by virtue of the construction and arrangement of the member for retaining the orthodontic wire, allows to obtain an optimal torsional and flexural rotational mobility of the wire itself within its own housing, yet it does not allow the wire to move in the direction of extraction (exit) from the housing or to become misaligned relative to the dental arc.

This allows to achieve an optimal therapeutic result in terms of dental alignment and corrections of patho-occlusions, as well as a reduction in the times required to obtain said desired therapeutic result.

Moreover, the arrangement of the invention allows to obtain a substantial reduction in the dimensions, and above all in the thickness, of the bracket itself, to the advantage of motion bio-mechanics and patient comfort in terms of tactile perception and speech. All this clearly also improves the patient's acceptance of the implant.

Other advantages, characteristics and the manners of employing the present invention shall become more readily apparent from the detailed description that follows of some embodiments, provided purely by way of non limiting example.

Reference shall be made to the figures of the accompanying drawings, in which:

FIG. 1 shows a perspective view of a first embodiment of the orthodontic bracket according to the present invention;

FIG. 2 shows another perspective view of the orthodontic bracket of FIG. 1 during its use in a lingual orthodontic implant;

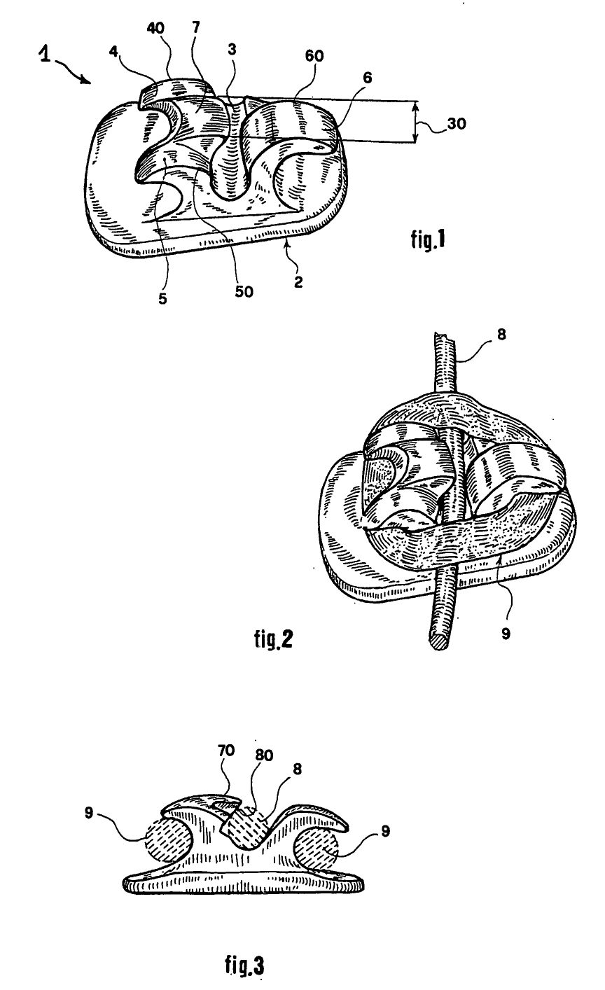

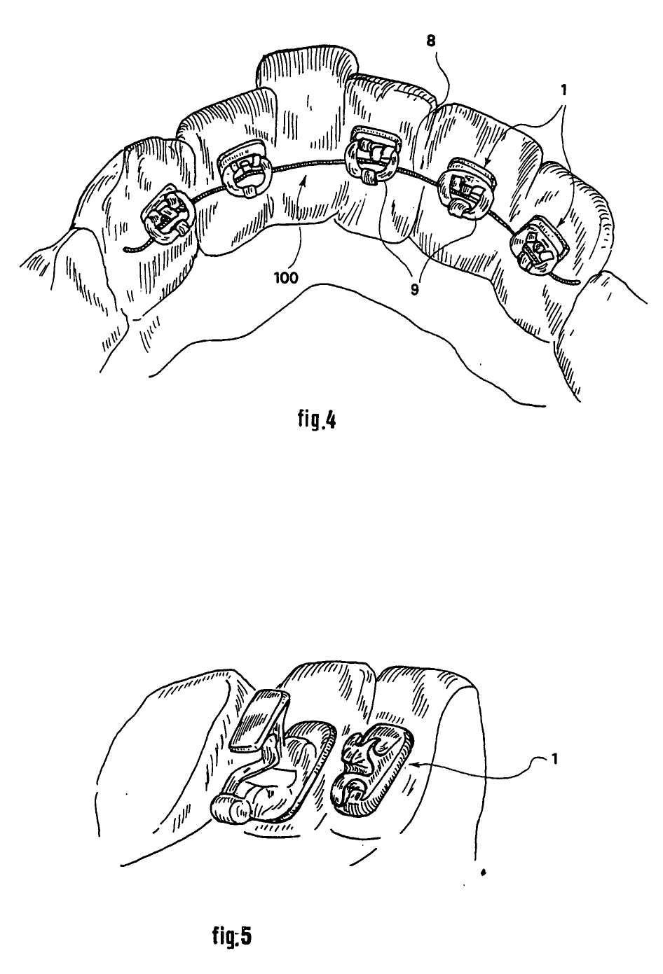

FIG. 3 shows a side view of the orthodontic bracket of FIG. 2;

FIG. 4 shows a perspective view of an orthodontic implant comprising a plurality of brackets like the one of FIG. 1; and

FIG. 5 shows a lateral perspective view of the orthodontic bracket of FIG. 1 compared with a prior art bracket.

With reference initially to FIGS. 1, 2 and 3, a bracket for lingual orthodontics according to the invention is globally designated as 1.

The orthodontic bracket 1 comprises a base 2 adapted to be fastened onto the lingual side of a tooth by means of conventional techniques, for instance by means of gluing. In the present embodiment, the base 2 has, when seen in plan view, a substantially trapezoidal profile with rounded angles.

The orthodontic bracket 1 further comprises a main body 20 rising from the base 2. The body 20 and the base 2, i.e. the whole bracket 1, are integral one with the other, and in particular constructed in a single piece.

On the body 20, in slightly raised position relative to the base 2, is obtained a housing 3 apt to receive an orthodontic wire 8, the latter shown in dashed lines in FIG. 3. In particular, said housing is in the form of a groove extending transversely relative to the base 2.

The housing 3 is apt to house orthodontic wires with circular cross section or with rectangular and/or square cross section, depending on the treatment stage and typology.

Preferably, for reasons which shall become readily apparent later on, the housing 3 is defined by two or more walls set longitudinally side by side, hence having in this case a cross section whose profile is a broken line rather than round.

The body 20 further comprises three engaging tabs projecting outwardly and able to engage and hold a system for binding the dental arc. More specifically, the bracket 1 comprises a first tab 4 and a second tab 5 substantially parallel and side by side with respect to each other and a third tab 6 arranged at the opposite side of the housing 3 relative to the other two tabs 4 and 5.

Each tab 4, 5 or 6 has a curved profile in order to more effectively perform its holding function and for a lower tactile perception of the patient's tongue.

The main body 20 further comprises a member 7 for retaining the orthodontic wire within the housing 3. In the present embodiment, the retaining member 7 is in the form of a protruding wedge-shaped fin positioned superiorly to the tabs 4, 5 and 6 and in a centred position relative to the housing 3. In particular, the member 7 is interposed between the first and the second tab 4 and 5 and oriented towards the opposite side with respect thereto.

According to the invention, the member 7 faces the housing 3 and extends only along a limited segment thereof, which segment is designated with an arrow 30 in FIG. 1.

As mentioned above, with the construction just described the bracket 1 can have thickness, defined as dimension comprised between the base 2 and the retaining member 7, within an interval of about 1÷1.2 mm.

The smaller thickness allowed by the bracket of the invention with respect to the prior art systems can be better appreciated also with reference to FIG. 5, in which the device 1 is shown next to a conventional device (lingual orthodontic bracket), i.e. the 7^{th} generation ORMCO Kurz.

Preferably, both the retaining member 7 and the tabs 4, 5 and 6 have a rounded outer profile, designated respectively by 40, 50, 60 and 70, apt not to injure the patient's tongue when the bracket 1 is fastened onto one of his/her teeth.

The manners of employing the invention shall now be illustrated with reference also to FIG. 4, which shows an orthodontic implant, globally designated by the reference 100, comprising a plurality of brackets 1 of the type described herein.

Each bracket 1 is fastened on the lingual side of a respective tooth in correspondence with its own base 2 by means of conventional techniques.

The orthodontic wire 8 is then received within the housing 3 of each bracket 1.

The wire 8 can have a round or polygonal, and in particular square or rectangular, cross section. In particular, the wire 8 can have square cross section with a thickness of about 0.0175 inches, and be made of a titanium-molybdenum or nickel-titanium alloy enabling torsion control, if needed.

By virtue of the conformation of the housing 3, the wire 8, if it has circular cross section, has a substantially linear instead of superficial contact with the walls of the housing 3. In this way, the friction associated with the coupling between wire 8 and housing 3 is reduced.

Moreover, as is more readily apparent from FIG. 3, an upper portion 80 of the wire segment 8 received in the housing 3 abuts against the retaining member 7. As stated previously, the member 7 is in contact only with a central portion of the segment of wire 8 received in the housing 3. This causes the wire 8 to be free in correspondence of the lateral ends of said segment, to the advantage of its flexural and torsional rotation mobility. At the same time, the abutment coupling between member 7 and wire 8 is effective in preventing movements of the wire 8 which tend to extract it from the housing 3.

Additionally, the tabs 4, 5 and 6 of each bracket 1 are engaged by an annular member 9 which provides a binding system for the arc. Said annular member can be, depending on the case, elastic or rigid, plastic or metal, and so on.

To the tabs 4, 5 and 6 can also be engaged little elastic chains which serve the function of binding the arc and, simultaneously, of providing containment (traction) between the brackets of the neighbouring teeth, in order to move whole groups of teeth or to make them approach each other.

It will be readily appreciated that the choice to use three engaging tabs to bind the arc allows a further reduction in the friction of the orthodontic wire in its own housing during the dental movements.

At this point it will also be more readily appreciated that the bracket of the invention allows to fully exploit the advantages of lingual implants, allowing to obtain a treatment that lasts the shortest possible time and limits the physical and psychological discomfort of the patient.

Furthermore, the reduced dimensions of the bracket of the invention, compared to those of the prior art, allow, among other advantages, to increase the distance between adjacent brackets of the implant 100, and hence to further increase the to flexibility of the orthodontic wires, with the result of a greater velocity of the dental movement, of greater control over rotation with a consequent reduction in treatment times.

Moreover, the orthodontic implant of the invention allows:
an easy direct or indirect mounting with or without the procedure for positioning the brackets on a customised ideal model, originating from the patho-occlusion, all in accordance with a treatment plan for what pertains to the dental movements on the three spatial planes (set-up);
an easy use of metallic and/or elastic bindings and of elastic tractions (little chains)—use of the elastic binding makes work faster and facilitates the patient's adaptation; and
a similar or even identical shape of the bracket for nearly all teeth of the upper and lower front sectors: a simplification is thereby obtained in terms of applicability and hence operability with a consequent cost reduction.

It will also be readily apparent that the present invention can be subject to numerous embodiments and variants, alternative to those described heretofore.

The present invention has been described thus far with reference to preferred embodiments. It is understood that there may be other embodiments which relate to the same inventive concept, all comprised within the scope of protection of the claims set out below.

1. A lingual orthodontic bracket, comprising:
a base adapted to be fastened onto the lingual side of a tooth;
a main body raising from the base, said main body being constructed in a single piece with the base and having a plurality of projecting engaging tabs apt to engage and retain a binding system-M for the dental arc;
a housing for an orthodontic wire which extends along the dental arc, said housing being interposed between the tabs and inclined so to form an acute angle with respect to the base, said acute angle opening towards a bottom of the tooth when the bracket is fastened onto the inclined lingual side of the tooth; and
a retaining member for retaining the orthodontic wire within said housing,
wherein said retaining member faces said housing and extends only along a limited segment of the latter, the arrangement being such that said retaining member abuts the orthodontic wire received in said housing.

2-14. (canceled)

15. An orthodontic implant for lingual orthodontics, comprising an orthodontic bracket as claimed in claim 1.

16. (canceled)

17. The orthodontic bracket as claimed in claim 1, wherein said retaining member is in the form of a projecting fin.

18. The orthodontic bracket as claimed in claim 1, wherein said retaining member has a substantially wedge shaped profile.

19. The orthodontic bracket as claimed in claim 1, wherein said retaining member is in a centred position relative to said housing.

20. The orthodontic bracket as claimed in claim 1, wherein said retaining member is integral with the remaining part of the bracket itself.

21. The orthodontic bracket as claimed in claim 1, wherein said retaining member is constructed in a single piece with the remaining part of the bracket itself.

22. The orthodontic bracket as claimed in claim 1, wherein said retaining member is arranged superiorly to the tabs of said plurality.

23. The orthodontic bracket as claimed in claim 1, wherein said retaining member has a rounded profile apt not to injure the patient's tongue.

24. The orthodontic bracket as claimed in claim 1, having a thickness, defined between said base and said retaining member, included in an interval of about 1÷1.2 mm.

25. The orthodontic bracket as claimed in claim 1, wherein said plurality of tabs comprises a first, a second and a third tab, said first and second tab being arranged at the opposite side of said housing with respect to said third tab.

26. The orthodontic bracket as claimed in claim 25, wherein said retaining member is arranged between said first and second tab and is oriented in the opposite direction relative thereto.

27. The orthodontic bracket as claimed in claim 1, wherein the tabs of said plurality have a rounded profile apt not to injure the patient's tongue.

28. The orthodontic bracket as claimed in claim 1, wherein said housing is in the form of a groove extending transversely relative to said base.

29. The orthodontic bracket as claimed in claim 1, wherein said housing is defined by two or more walls set longitudinally side by side, having a cross section with a broken-line profile.

30. The orthodontic implant as claimed in claim 15, comprising an orthodontic wire apt to be inserted in said housing and, in such an arrangement, to abut said retaining member.
